(19) United States
(12) Patent Application Publication
(10) Pub. No.: US 2026/0349904 A1
(43) Pub. Date: Nov. 5, 2026

(54) Predicting Application Resiliency Issues Using Machine Learning Techniques

(71) Applicant: STATE FARM MUTUAL AUTOMOBILE INSURANCE COMPANY, Bloomington, IL (US)

(72) Inventors: Ryan Jewell, Bloomington, IL (US); Ryan Chambers, Bloomington, IL (US); Sean Harmon, Towanda, IL (US); Nathan Shepherd, Bloomington, IL (US); Andrew Kirfman, Flagstaff, AZ (US); John MacNeil, Macon, GA (US)

(21) Appl. No.: 19/740,202

(22) Filed: Jul. 13, 2026

Related U.S. Application Data
(63) Continuation-in-part of application No. 18/220,537, filed on Jul. 11, 2023, now Pat. No. 12,754,822.
(60) Provisional application No. 63/456,714, filed on Apr. 3, 2023.
(60) Provisional application No. 64/057,204, filed on May 4, 2026.

(51) Int. Cl. G06F 11/362

(52) U.S. Cl. CPC G06F 11/3636

(57) ABSTRACT

Techniques are described for analyzing software application dependencies in an enterprise software system using a knowledge graph. A computer-implemented method includes transforming software data into nodes and edges according to a predefined graph schema. Each node represents an entity within a software architecture, each edge represents a relationship between entities, and entities include software components and infrastructure resources. The method also includes constructing a knowledge graph in a graph database from the nodes and edges. The knowledge graph integrates source code data with runtime dependency data. The method includes analyzing the software architecture by executing, using software agents, graph traversal queries against the knowledge graph to determine dependency chains between entities, and determining an impact scope for a change or failure event by tracing upstream and downstream dependencies from an originating entity. Additionally, the method includes automatically implementing a software remediation action in response to the determined impact scope.

### CROSS-REFERENCE TO RELATED APPLICATIONS

This application claims priority to and the benefit of the filing date of provisional U.S. Patent Application No. 64/057,204 entitled “Predicting Application Resiliency Issues Using Machine Learning Techniques,” filed on May 4, 2026. This application is also a continuation-in-part of U.S. Patent Application No. 18/220,537 entitled “Predicting Application Resiliency Issues Using Machine Learning Techniques,” filed on July 11, 2023, which claims priority to and the benefit of the filing date of provisional U.S. Patent Application No. 63/456,714 entitled “Predicting Application Resiliency Issues Using Machine Learning Techniques,” filed on Apr. 3, 2023. The entire contents of each of the above-referenced applications is hereby expressly incorporated herein by reference.

### TECHNICAL FIELD

The present disclosure generally relates to analyzing software application dependencies. More specifically, the disclosure relates to constructing and utilizing a centralized knowledge graph to integrate source code information, runtime dependency data, and configuration data to enable resiliency issue prediction using software agents.

### BACKGROUND

Modern enterprise software systems have numerous interconnected components, including source code repositories, deployment pipelines, runtime services, and infrastructure resources. Organizations rely on various monitoring and observability tools to track the health and performance of these distributed systems. Application performance monitoring platforms collect runtime telemetry data, while source code management systems maintain version control information and change histories. However, these data sources typically operate in isolation, with each tool providing visibility into only a portion of the overall system architecture. Approaches to understanding application dependencies involve slow documentation efforts or rely on individual monitoring tools that captured limited aspects of system relationships. Correlating information across disparate sources to understand the full scope of upstream and downstream dependencies within complex application ecosystems remains challenging, particularly when attempting to trace the impact of changes or failures across multiple layers.

### BRIEF SUMMARY

One exemplary embodiment of the present disclosure may be a computer-implemented method for analyzing software application dependencies in an enterprise software system using a knowledge graph. The computer-implemented method may be implemented by one or more local or remote processors, servers, sensors, transceivers, memory units, bots (such as voice bots, chatbots, ChatGPT-based bots), and/or other electronic or electrical components, which may be in wired or wireless communication with one another. In one aspect, the computer-implemented method for analyzing software application dependencies may include: (1) transforming, by one or more processors, software data into one or more (i) nodes and (ii) edges according to a predefined graph schema, wherein each node of the one or more nodes represents an entity within a software architecture, each edge of the one or more edges represents a relationship between entities, and entities include software components and infrastructure resources within the software architecture; (2) constructing, by the one or more processors, a knowledge graph in a graph database from the one or more nodes and the one or more edges, wherein the knowledge graph integrates source code data with runtime dependency data; (3) executing, by the one or more processors using one or more software agents, graph traversal queries against the knowledge graph to determine dependency chains between the entities; (4) determining, based upon the determined dependency chains, an impact scope for a change or failure event within the software architecture by tracing upstream and downstream dependencies from an originating entity; and/or (5) automatically implementing, by the one or more processors, a software remediation action in response to the determined impact scope. The method may include additional, less, or alternate actions, including those discussed elsewhere herein.

For instance, in some embodiments, at least one software agent of the one or more software agents may include executable software configured to (i) access the knowledge graph, (ii) process query results, or (iii) initiate operations based upon one or more predefined conditions or learned patterns, and the at least one software agent may perform graph enrichment and validation operations including at least one of: schema compliance validation on one or more nodes for properties; temporal consistency analysis to flag data not updated within a predefined time period; relationship integrity checking to identify broken links or circular dependencies; identifying missing ownership for entities; identifying documentation gaps for repositories; identifying orphaned resources not linked to any service; and/or creating derived relationships by analyzing patterns across existing nodes and edges in the knowledge graph.

Also in some embodiments, at least one software agent of the one or more software agents may use a large language model (LLM) to semantically analyze the knowledge graph, including at least one of: extracting purpose and capabilities from documentation, categorizing services by function, and/or determining dependency rationale for connections between services based upon code references, configuration settings, or communication patterns.

In some embodiments, the knowledge graph may include telemetry nodes representing performance metrics associated with service entities, wherein the performance metrics include at least one of latency measurements, error rates, availability metrics, throughput measurements, or resource utilization data, and determining the impact scope may include correlating detected anomalies with contributing factors by at least one of: calculating similarity metrics by comparing patterns in the performance metrics across multiple service entities to identify services exhibiting correlated degradation; and/or correlating detected anomalies with code changes occurring within a predefined time window by traversing the knowledge graph to identify commits and deployments temporally associated with the anomalies.

In some embodiments, the computer-implemented method may further include: (1) associating, by the one or more processors, each node with source provenance metadata including a source system identifier and a last updated timestamp; and/or (2) tagging, by the one or more processors, agent-generated data with an agent source identifier, a confidence score, and a creation timestamp.

In some embodiments, the computer-implemented method may further include: (1) providing, by the one or more processors, access to the knowledge graph through an application programming interface configured to receive queries from users, external systems, and the one or more software agents and to return query results while preserving graph traversal capabilities; and/or (2) causing, by the one or more processors, a visual representation of at least a portion of the knowledge graph to be displayed by a user interface, wherein the visual representation includes at least one of a dependency map, an impact visualization, or an entity relationship diagram.

In some embodiments, the computer-implemented method may further include: (1) simulating, by the one or more processors, propagation of the change or failure event through the knowledge graph to predict one or more impacts on downstream entities; and/or (2) identifying, by the one or more processors based upon the simulating, a candidate resolution prior to implementing the software remediation action.

In some embodiments, the computer-implemented method may further include: (1) comparing, by the one or more processors, declared dependencies derived from the source code data with observed dependencies derived from the runtime dependency data; and/or (2) identifying a dependency mismatch where a declared dependency differs from an observed dependency.

Also in some embodiments, the software remediation action may include at least one of: initiating a rollback of a deployment associated with the change or failure event, adjusting resource allocation for an affected service identified within the dependency chains, modifying traffic routing to bypass a component identified as failing within the impact scope, scaling computing resources allocated to one or more services within the impact scope, and/or generating and transmitting an alert to a designated operations channel identifying the impact scope and affected entities.

Another exemplary embodiment of the present disclosure may be a computer system for analyzing software application dependencies in an enterprise software system using a knowledge graph. The computer system may include one or more processors, servers, sensors, transceivers, memory units, bots (such as voice bots, chatbots, ChatGPT-based bots), and/or other electronic or electrical components that may be in wired or wireless communication with one another. In one instance, the system may include one or more processors, and a non-transitory computer-readable memory coupled to the one or more processors that stores instructions, that, when executed by the one or more processors, may cause the system to: (1) transform software data into one or more (i) nodes and (ii) edges according to a predefined graph schema, wherein each node of the one or more nodes represents an entity within a software architecture, each edge of the one or more edges represents a relationship between entities, and entities include software components and infrastructure resources within the software architecture; (2) construct a knowledge graph in a graph database from the one or more nodes and the one or more edges, wherein the knowledge graph integrates source code data with runtime dependency data; (3) execute, using one or more software agents, graph traversal queries against the knowledge graph to determine dependency chains between the entities; (4) determine, based upon the determined dependency chains, an impact scope for a change or failure event within the software architecture by tracing upstream and downstream dependencies from an originating entity; and/or (5) automatically implement a software remediation action in response to the determined impact scope. The system may include additional, less, or alternate functionality, including that discussed elsewhere herein.

For instance, in some embodiments, at least one software agent of the one or more software agents may include executable software configured to (i) access the knowledge graph, (ii) process query results, or (iii) initiate operations based upon one or more predefined conditions or learned patterns, and the at least one software agent may perform graph enrichment and validation operations including at least one of: schema compliance validation on one or more nodes for properties, temporal consistency analysis to flag data not updated within a predefined time period, relationship integrity checking to identify broken links or circular dependencies, identifying missing ownership for entities, identifying documentation gaps for repositories, identifying orphaned resources not linked to any service, and/or creating derived relationships by analyzing patterns across existing nodes and edges in the knowledge graph.

Also in some embodiments, at least one software agent of the one or more software agents may use a large language model (LLM) to semantically analyze the knowledge graph, including at least one of: extracting purpose and capabilities from documentation, categorizing services by function, and/or determining dependency rationale for connections between services based upon code references, configuration settings, or communication patterns.

In some embodiments, the knowledge graph may include telemetry nodes representing performance metrics associated with service entities, wherein the performance metrics include at least one of latency measurements, error rates, availability metrics, throughput measurements, or resource utilization data, and determining the impact scope may include correlating detected anomalies with contributing factors by at least one of: calculating similarity metrics by comparing patterns in the performance metrics across multiple service entities to identify services exhibiting correlated degradation, and/or correlating detected anomalies with code changes occurring within a predefined time window by traversing the knowledge graph to identify commits and deployments temporally associated with the anomalies.

In some embodiments, the instructions, when executed by the one or more processors, may further cause the one or more processors to: (1) associate each node with source provenance metadata including a source system identifier and a last updated timestamp; and/or (2) tag agent-generated data with an agent source identifier, a confidence score, and a creation timestamp.

In some embodiments, the instructions, when executed by the one or more processors, may further cause the one or more processors to: (1) provide access to the knowledge graph through an application programming interface configured to receive queries from users, external systems, and the one or more software agents and to return query results while preserving graph traversal capabilities; and/or (2) cause a visual representation of at least a portion of the knowledge graph to be displayed by a user interface, wherein the visual representation includes at least one of a dependency map, an impact visualization, or an entity relationship diagram.

In some embodiments, the instructions, when executed by the one or more processors, may further cause the one or more processors to: (1) simulate propagation of the change or failure event through the knowledge graph to predict one or more impacts on downstream entities; and/or (2) identify, based upon the simulating, a candidate resolution prior to implementing the software remediation action.

In some embodiments, the instructions, when executed by the one or more processors, may further cause the one or more processors to: (1) compare declared dependencies derived from the source code data with observed dependencies derived from the runtime dependency data; and/or (2) identify a dependency mismatch where a declared dependency differs from an observed dependency.

Also in some embodiments, the software remediation action may include at least one of: initiating a rollback of a deployment associated with the change or failure event, adjusting resource allocation for an affected service identified within the dependency chains, modifying traffic routing to bypass a component identified as failing within the impact scope, scaling computing resources allocated to one or more services within the impact scope, and/or generating and transmitting an alert to a designated operations channel identifying the impact scope and affected entities.

Yet another exemplary embodiment of the present disclosure may be a non-transitory computer-readable storage medium storing executable instructions for analyzing software application dependencies in an enterprise software system using a knowledge graph. In one instance, the instructions, when executed by one or more processors, may cause the one or more processors to: (1) transform software data into one or more (i) nodes and (ii) edges according to a predefined graph schema, wherein each node of the one or more nodes represents an entity within a software architecture, each edge of the one or more edges represents a relationship between entities, and entities include software components and infrastructure resources within the software architecture; (2) construct a knowledge graph in a graph database from the one or more nodes and the one or more edges, wherein the knowledge graph integrates source code data with runtime dependency data; (3) execute, using one or more software agents, graph traversal queries against the knowledge graph to determine dependency chains between the entities; (4) determine, based upon the determined dependency chains, an impact scope for a change or failure event within the software architecture by tracing upstream and downstream dependencies from an originating entity; and/or (5) automatically implement a software remediation action in response to the determined impact scope. The non-transitory computer-readable storage medium may include additional, less, or alternate functionality, including that discussed elsewhere herein.

For instance, in some embodiments, at least one software agent of the one or more software agents may include executable software configured to (i) access the knowledge graph, (ii) process query results, or (iii) initiate operations based upon one or more predefined conditions or learned patterns, and the at least one software agent may perform graph enrichment and validation operations including at least one of: schema compliance validation on one or more nodes for properties, temporal consistency analysis to flag data not updated within a predefined time period, relationship integrity checking to identify broken links or circular dependencies, identifying missing ownership for entities, identifying documentation gaps for repositories, identifying orphaned resources not linked to any service, and/or creating derived relationships by analyzing patterns across existing nodes and edges in the knowledge graph.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 depicts a block diagram of an example computing environment for analyzing software application dependencies using a knowledge graph, according to one embodiment;

FIG. 2 illustrates a system diagram of an example flow for analyzing software application dependencies using a knowledge graph, according to one embodiment;

FIG. 3 illustrates a system diagram of an example flow for dependency chain determination, anomaly correlation, simulation, and dependency mismatch detection, according to one embodiment;

FIG. 4 depicts a system diagram of an example agent operations sub-flow for enriching and validating a knowledge graph using software agents, according to one embodiment;

FIG. 5 depicts a system diagram of an example impact scope visualization showing upstream root cause tracing and downstream blast radius determination, according to one embodiment; and

FIG. 6 illustrates a flowchart of an exemplary computer-implemented or computer-based method for analyzing software application dependencies using a knowledge graph, which may be implemented by a server, according to one embodiment.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Techniques, systems, apparatuses, components, devices, and/or methods are disclosed for, inter alia, analyzing software application dependencies in software systems utilizing a knowledge graph. The present techniques ingest data from multiple source systems, such as source code management platforms and runtime monitoring platforms, and transform that data into an interconnected graph structure. Software agents then traverse this graph to trace how software components depend on one another, determine which parts of the system are affected when something changes or fails, and automatically take corrective action. The techniques enable interpretability of a software architecture in a unified manner, rather than piecing together information from disconnected monitoring tools. For example, when a service experiences elevated error rates, the techniques can trace backward through the graph to identify the specific code commit that introduced the problem, and trace forward to identify downstream services that may be affected, information that would otherwise be unavailable across multiple systems.

Enterprise software systems generate software data across isolated source systems. Source code management systems maintain version control information and change histories, while runtime monitoring systems collect telemetry data including latency measurements, error rates, and availability metrics. These source systems operate independently, each providing visibility into only a portion of the overall system architecture. When a change or failure event occurs, these systems cannot trace the full scope of upstream and downstream dependencies because no single data source contains the cross-domain relationship information needed to determine the impact scope. This results in correlation efforts that delay remediation, extend system outages, and increase operational costs.

To address this technical problem, the disclosed techniques transform software data from multiple source systems into nodes and edges according to a predefined graph schema, where each node represents an entity within a software architecture, each edge represents a relationship between entities, and entities include software components and infrastructure resources within the software architecture. A knowledge graph is constructed in a graph database from the nodes and edges, where the knowledge graph integrates source code data with runtime dependency data. This graph-based architecture enables the computer to model relationships as first-class data elements, traverse dependency paths across multiple hops regardless of the number of intermediate entities, and correlate information across previously disconnected data domains. The graph schema defines relationship types (e.g., service dependency relationships such as CALLS, deployment relationships such as DEPLOYED_AS, and ownership relationships such as OWNS) as data elements that encode semantic connections between entities.

Using software agents, the disclosed system executes graph traversal queries against the knowledge graph to determine (e.g., discover) dependency chains between entities. Based upon the discovered dependency chains, an impact scope for a change or failure event within the software architecture is determined by tracing upstream and downstream dependencies from an originating entity. This bidirectional traversal enables the computer to follow a chain from an incident back through a service, a deployment pipeline, a commit, and an author that introduced the incident, or to find services multiple hops (e.g., intermediate dependency connections between entities) downstream to understand a blast radius (e.g., the total set of services and components affected by a failure event propagating through dependency chains). A software remediation action is automatically implemented in response to the determined impact scope. The software remediation action may include initiating a rollback of a deployment, adjusting resource allocation for an affected service, modifying traffic routing to bypass a failing component, scaling computing resources, generating and transmitting an alert to a designated operations channel, etc.

The knowledge graph may include telemetry nodes representing performance metrics associated with service entities, where the performance metrics include latency measurements, error rates, availability metrics, throughput measurements, or resource utilization data. Determining the impact scope may include correlating detected anomalies with contributing factors by calculating similarity metrics that compare patterns in the performance metrics across multiple service entities to identify services exhibiting correlated degradation, or by correlating detected anomalies with code changes occurring within a predefined time window by traversing the knowledge graph to identify commits and deployments temporally associated with the anomalies.

Source provenance metadata may be associated with each node, including a source system identifier and a last updated timestamp. Agent-generated data may be tagged with an agent source identifier, a confidence score, and a creation timestamp. This provenance tracking enables users and systems to distinguish between data ingested from source systems and data derived by software agents, and to assess the timeliness (e.g., how recently data was updated from its source system) and reliability of information in the knowledge graph.

In some aspects, software agents operating within the system include executable software that queries the knowledge graph, analyzes returned results, and initiates operations when predefined conditions are met or when learned patterns are detected. Graph enrichment and validation operations performed by the software agents may include schema compliance validation on one or more nodes for properties, temporal consistency analysis to flag data not updated within a predefined time period, relationship integrity checking to identify broken links or circular dependencies, identifying missing ownership for entities, identifying documentation gaps for repositories, identifying orphaned resources not linked to any service, and creating derived relationships by analyzing patterns across existing nodes and edges in the knowledge graph.

Semantic analysis of the knowledge graph may be performed using a large language model, including extracting purpose and capabilities from documentation, categorizing services by function, and determining dependency rationale for connections between services based upon code references, configuration settings, or communication patterns. Propagation of change or failure events through the knowledge graph may be simulated to predict downstream impacts and identify candidate resolutions prior to implementing remediation. Additionally, declared dependencies derived from source code data may be compared with observed dependencies derived from runtime dependency data to identify dependency mismatches, detecting configuration drift where the actual runtime behavior of the system diverges from what the source code declares.

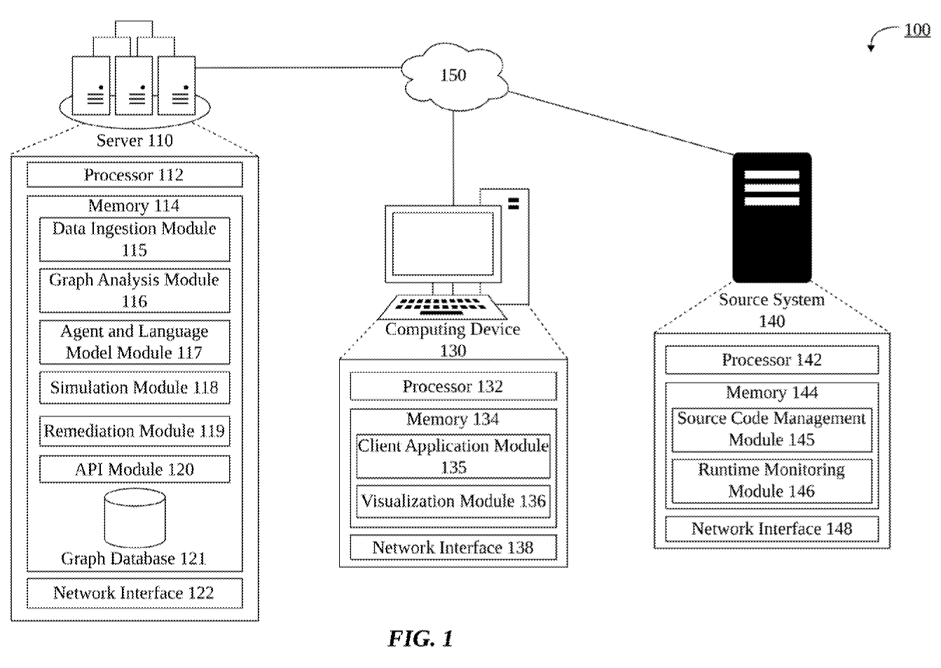

In some aspects, the disclosed techniques provide simulation benefits that enable proactive error prevention. Rather than implementing code changes, identifying errors in the production system, and then correcting them after users have been affected, the system may simulate proposed changes through the knowledge graph to identify potential errors without harmful effects or performance issues for users. A simulation module, described below with reference to FIG. 1, may model how a proposed code change would propagate through the dependency chains, predict which downstream services would be affected, and identify potential failure modes before the change is deployed. Potential errors may be corrected before deployment, that may result in the reduced possibility of failure associated with software deployments. Thus, the present techniques enable proactive evaluation of the consequences due to changes in a safe environment that mirrors the production architecture.

The disclosed techniques may also provide error detection and correction benefits by correlating information across previously disconnected domains. By integrating source code data with runtime dependency data in a unified knowledge graph, the system may enable faster identification of root causes and more accurate determination of affected components. When an anomaly is detected, the system may traverse the knowledge graph to correlate the anomaly with recent code changes, deployment events, and performance patterns across related services. This cross-domain correlation may reduce the time required to diagnose issues across multiple monitoring tools to automated traversal that surfaces relevant information. The graph-based architecture may enable the system to identify relationships between entities that would otherwise remain hidden when data sources operate in isolation, improving the accuracy of error attribution and reducing false positives in anomaly detection.

Additionally, the disclosed techniques may improve application resiliency by automatically implementing remediation actions that address detected issues. The automatic remediation actions may reduce error rates and improve system uptime, addressing problems with computer networks and computing systems where cascading failures propagate through interconnected services. By automatically initiating rollbacks, adjusting resource allocation, modifying traffic routing, or scaling computing resources in response to detected issues, the system may reduce the duration and severity of outages. The remediation module, as described below with reference to FIG. 1, may take corrective action faster than user intervention would allow, limiting the blast radius of failures and preventing degradation from spreading to additional downstream services. This automated response capability may improve the overall resiliency of the software architecture by enabling the system to self-heal in response to detected anomalies, reducing operational costs associated with incident response and minimizing the impact of failures on end users.

### I.EXAMPLE ENVIRONMENT FOR ANALYZING SOFTWARE DEPENDENCIES USING A KNOWLEDGE GRAPH

FIG. 1 depicts a block diagram of a computing environment 100 for analyzing software application dependencies in an enterprise software system using a knowledge graph. The computing environment 100 may include a server 110, a computing device 130, and/or a source system 140, which may be communicatively connected through a network 150. According to certain embodiments, the server 110 may be a combination of hardware and software components, as described in more detail below.

The server 110 may include one or more processors 112, such as a microprocessor, coupled to a memory 114. The memory 114 may be tangible, non-transitory memory and may include any types of suitable memory components, including random access memory (RAM), read-only memory (ROM), electronic programmable read-only memory (EPROM), erasable electronic programmable read-only memory (EEPROM), flash memory, MicroSD cards, and other types of persistent memory, etc. The memory 114 may store instructions executable on the processor 112 for a data ingestion module 115, a graph analysis module 116, an agent and language model module 117, a simulation module 118, a remediation module 119, and/or an API module 120. The server 110 may also include a graph database 121 for storing the knowledge graph and a network interface 122 for communication over the network 150.

The data ingestion module 115 may ingest and convert raw data from source systems into graph-compatible structures, including nodes that correspond to entities within a software architecture and edges that encode relationships between those entities. Entities may encompass software components such as services, repositories, and pipelines, as well as infrastructure resources such as hosts, databases, and network endpoints. The data ingestion module 115 may assemble these nodes and edges into a knowledge graph stored in the graph database 121, where the knowledge graph unifies source code information with runtime dependency information. The data ingestion module 115 may also extract and process configuration data in addition to source code and runtime data to create a more complete representation of system dependencies.

The computing environment 100 may include multiple specialized workers that operate as part of the data ingestion module 115. A source code worker may connect to a source code management platform (e.g., GitLab®) to extract repository, branch, commit, merge request, and CI/CD pipeline information. A runtime monitoring worker may pull runtime data from a runtime monitoring platform (e.g., Dynatrace®) and derive associations not available from the runtime monitoring platform alone. Each node in the knowledge graph may have a particular canonical identifier derived from its source system, enabling idempotent updates and cross-worker linking.

The data ingestion module 115 may operate according to design principles including idempotent operations, incremental updates, and schema compliance. Idempotent operations may enable workers to re-run safely without creating duplicate data because each entity may have a particular canonical identifier derived from its source system. Incremental updates may enable workers to track what they have processed and fetch new or changed content on subsequent runs. Schema compliance may involve workers adhering to a shared schema to promote consistent node labels and relationship types across sources.

The source code worker may create entities (e.g., Repository, Branch, Commit, MergeRequest, Pipeline, Job nodes, etc.) with various relationships which may include branch relationships (e.g., Repository to HAS_BRANCH to Branch), trigger relationships (e.g., Commit to TRIGGERED to Pipeline), and authorship relationships (e.g., MergeRequest to AUTHORED_BY to User). The runtime monitoring worker may create entities (e.g., Service, Process, Host, Database, Endpoint nodes, etc.) with various relationships which may include service dependency relationships (e.g., Service to CALLS to Service), hosting relationships (e.g., Service to RUNS_ON to Host), and resource usage relationships (e.g., Service to USES to Database).

In some implementations, additional workers may be created by identifying a source system and its API capabilities, mapping source entities to the graph schema, implementing extraction and transformation logic, defining cross-domain linking rules (e.g., how to connect to existing nodes), and configuring scheduling and error handling. For example, additional workers may include functionality for ingesting incident and change management data, ingesting documentation and knowledge base content, and/or workers for other source systems within the enterprise environment. In some implementations, the computing environment 100 may include multiple workers that collectively contribute to the knowledge graph schema.

The data ingestion module 115 may operate in batch mode, real-time mode, or both. In batch mode, worker applications may run on predefined schedules to ingest updated data from source systems at regular intervals. In real-time mode, worker applications may respond to events such as new deployments, code commits, or detected anomalies to ingest data as changes occur. In some implementations, the data ingestion module 115 may use the knowledge graph to understand what entities are tied to a particular deployment, enabling targeted ingestion of relevant data when a production change occurs.

### A.EXAMPLE GRAPH ANALYSIS MODULE

The graph analysis module 116 may use software agents to run queries that traverse the knowledge graph and determine (e.g., discover) how entities depend on one another. The graph analysis module 116 may analyze the software architecture by executing graph traversal queries to determine dependency chains and determine an impact scope based upon the determined dependency chains. Based upon the discovered dependency relationships, the graph analysis module 116 may assess which portions of the system are affected when a change or failure occurs by following dependency paths both upstream (toward root causes) and downstream (toward affected consumers) from an originating entity.

The graph database 121 may enable complex queries that span different domains, such as linking a deployment in the runtime monitoring system back to the commit in the source code management system that triggered it. Example graph traversal queries may include: finding all services affected by a repository change by traversing from Repository through deployment relationships (e.g., DEPLOYED_AS) and service dependency relationships (e.g., CALLS); tracing a failure back to its source by traversing from an Incident through causal relationships (e.g., CAUSED), deployment relationships (e.g., DEPLOYED_AS), trigger relationships (e.g., TRIGGERED), and authorship relationships (e.g., AUTHORED) to identify the User who authored the commit that introduced the failure; and discovering service dependencies up to 3 hops downstream to understand the blast radius.

In some implementations, the graph analysis module 116 may perform anomaly detection using multiple anomaly detection models with similarity metrics such as cosine similarity across applications and metrics to determine if error rates follow similar patterns indicating an association. The graph analysis module 116 may also perform temporal correlation using a time window before and up to the time of evaluation across the dependency tree to identify code changes temporally associated with detected anomalies.

### B.EXAMPLE AGENT AND LANGUAGE MODEL MODULE

The agent and language model module 117 may implement software agents that query the knowledge graph, analyze the results, and take action when predefined conditions are met or when learned patterns are detected. Agent-created data may be tagged with provenance information including an agent source identifier, a confidence score, and a creation timestamp.

The software agents may perform gap analysis operations including: identifying missing ownership for services without an assigned team or owner, identifying documentation gaps for repositories with no README or outdated documentation, identifying orphaned resources for infrastructure not linked to any service, and identifying stale connections for relationships that have not been validated recently. The software agents may also perform inferred connection operations including: name matching by linking a source code repository to a runtime service with the same name, configuration parsing by reading deployment manifests to connect repositories to clusters, and semantic similarity by grouping services that appear to be related based upon naming conventions.

The software agents may be distinguished from the workers of the data ingestion module 115. Workers may pull data from external source systems, create primary entities, run on schedules, and be source-system focused. Agents may analyze the graph itself, create derived insights, and be cross-domain focused. In some implementations, agents may run after workers complete their ingestion cycles, or agents may run on independent schedules. The large language model may use the graph schema for context to write better queries without passing the schema with every prompt. The software agents may be triggered to execute after worker applications complete their ingestion cycles, on a predefined schedule, or in response to detected events such as a new deployment or an anomaly alert. In some implementations, agents may execute continuously as background processes that monitor the knowledge graph for changes.

The large language model used by the agent and language model module 117 may operate without fine-tuning or additional training specific to the knowledge graph. Instead, the large language model may leverage the graph schema as context to understand how to traverse and analyze the knowledge graph. The graph schema may be provided to the large language model as part of a prompt, enabling the large language model to generate appropriate graph traversal queries (e.g., Cypher queries) for navigating the knowledge graph. In some implementations, the graph schema may be stored in a format accessible to the large language model, reducing the need to pass the full schema with every prompt. The large language model may receive a prompt including the graph schema, relevant node and edge data retrieved from a query, and a natural language instruction describing the analysis task to be performed.

The output of the large language model may include natural language summaries describing service purpose and capabilities, structured service category classifications, dependency rationale annotations explaining why services are connected, and/or graph traversal queries (e.g., Cypher queries) for navigating the knowledge graph. The output of the large language model may be stored in the knowledge graph as node properties or edge annotations, tagged with an agent source identifier and a confidence score.

The confidence score associated with agent-generated data may reflect the derivation depth of the data. Data ingested directly from source systems (e.g., a service node created by the runtime monitoring worker) may receive a higher confidence score than data derived through agent analysis (e.g., an inferred relationship created by name matching). Data derived through multiple layers of inference may receive progressively lower confidence scores. In some implementations, foundational data ingested from source systems may be treated as more reliable, while further derivations built on top of that data may be assigned progressively lower confidence levels.

### C.EXAMPLE SIMULATION MODULE

The simulation module 118 may simulate propagation of the change or failure event through the knowledge graph to predict one or more impacts on downstream entities. The simulation module 118 may implement source code in a graph form representing a physical layer of what has been deployed, simulate an error in production, and identify (e.g., find) a resolution against the simulation. The simulation module 118 may identify, based upon the simulation, a candidate resolution prior to implementing a software remediation action.

In some implementations, the simulation module 118 may use a code representation format, such as an abstract syntax tree (AST) format, to capture the syntax and how the system works together without requiring the actual source code. Other code representation formats may include control flow graphs, data flow graphs, intermediate representations that model system behavior, etc. The simulation module 118 may traverse up and down tree to tree and also temporally between trees, re-running scenarios to see how changes are implemented. The simulation module 118 may identify self-healing opportunities where the large language model detects a root cause, identifies the outcome of changes, and simulates those changes through a data run. The breadth of content in the knowledge graph may power the simulation including data quality expectations and larger dependency chains.

In further implementations, the simulation module 118 may include synthetic users that perform typical day-to-day functions within the system to test whether a proposed code change causes a rise in error rates. The simulation may model an entire organization with different departments using different systems. For example, the simulation may include synthetic users representing different organizational roles (e.g., HR personnel using an HR management system, IT staff using infrastructure management systems, legal teams using document management systems, and/or finance departments using accounting systems). Each synthetic user may perform typical functions within their respective systems (e.g., submitting requests, processing transactions, generating reports, or accessing records). The simulation module 118 may monitor whether there is a rise in error rates or errors specific to a proposed code change to determine whether the code change negatively affects the system. The simulation may be iteratively repeated with corrections applied until the error rate no longer correlates with the code change, enabling developers to refine the proposed change before deployment. This approach may enable proactive error prevention, where problems are identified and corrected before deployment rather than after users have been affected.

### D.EXAMPLE REMEDIATION AND API MODULES

The remediation module 119 may take automated corrective action based upon the assessed scope of impact. The software remediation action may include at least one of: initiating a rollback of a deployment associated with the change or failure event, adjusting resource allocation for an affected service identified within the dependency chains, modifying traffic routing to bypass a component identified as failing within the impact scope, scaling computing resources allocated to one or more services within the impact scope, and/or generating and transmitting an alert to a designated operations channel identifying the impact scope and affected entities. In some implementations, the output of the remediation module 119 may include merge request code as automated code change recommendations. The merge request code may include executable code changes that address detected issues, such as fixing identified bugs, updating configuration settings, or modifying dependency declarations. The remediation module 119 may generate the merge request code based upon analysis of the root cause and may submit the merge request code to a source code management system (e.g., the source code management module 145 of the source system 140) for review and deployment.

The API module 120 may provide access to the knowledge graph through an application programming interface configured to receive queries from users, external systems, and the one or more software agents and to return query results while preserving graph traversal capabilities. The primary API may be a GraphQL® API which naturally maps to graph data structures, allowing clients to request exactly the fields and relationships they need. The API module 120 may also provide REST endpoints for simple lookups and integrations that do not require graph traversal.

The consumption layer provided by the API module 120 may support three consumption pathways: human users who explore via a user interface and run searches to view entity details and relationships; systems that integrate via API for automation, alerting, and cross-platform workflows; and AI agents that query graph context for LLM-powered analysis and automation. The API module 120 may implement role-based access control through integration with an identity provider, wherein viewers can browse and search the graph, contributors can add annotations and feedback, and admins can manage workers and agent configurations.

The graph database 121 may be implemented using Neo4j® or any other suitable graph database technology. The graph database 121 may enable graph traversal queries using query languages such as Cypher. Traditional relational databases may excel at storing structured tabular data with predefined relationships, but the engineering landscape may be intensely interconnected where repositories link to pipelines, pipelines deploy services, services call other services, and failures cascade through these connections. The graph database 121 may provide advantages including: modeling real relationships where relationships are first-class citizens rather than join tables; traversing efficiently to find paths between entities in milliseconds regardless of how many hops are involved; evolving flexibly to add new node types and relationships without schema migrations or downtime; and querying intuitively where Cypher queries read like natural language making complex traversals accessible.

### E.EXAMPLE COMPUTING DEVICE

The computing device 130 may include one or more processors 132, a memory 134, and a network interface 138. The memory 134 may store a client application module 135 and a visualization module 136. The client application module 135 may enable users to interact with the computing environment 100. The visualization module 136 may render visual representations of the knowledge graph on a display, including dependency maps that show how services connect to one another, impact visualizations that highlight the scope of a failure event, and entity relationship diagrams that depict the connections between components in the software architecture.

The computing device 130 may include, by way of example, a tablet computer, a cell phone, a personal digital assistant (PDA), a mobile device smart-phone, a laptop computer, a desktop computer, a portable media player, a wearable computing device, smart glasses, smart watches, or other smart devices configured for wired or wireless communication. In some implementations, the visualization module 136 may display an interactive graph visualization displaying nodes and edges representing entities and relationships within the knowledge graph. A user may interact with the visualization to select a particular node, causing the user interface to highlight the edges and connected nodes associated with the selected node, thereby revealing the dependency relationships for that particular entity.

### F.EXAMPLE SOURCE SYSTEM

The source system 140 may include one or more processors 142, a memory 144, and a network interface 148. The memory 144 may store a source code management module 145 and a runtime monitoring module 146. The source code management module 145 may maintain source code data including version control information and change histories. The runtime monitoring module 146 may collect runtime dependency data including telemetry and performance metrics from deployed services.

### G.EXAMPLE NETWORK

The network 150 may be a proprietary network, a secure public Internet, a virtual private network, and/or some other type of network facilitating communication between the server 110, the computing device 130, and the source system 140, such as dedicated access lines, plain ordinary telephone lines, satellite links, combinations of these, etc. Where the network 150 comprises the Internet, data communication may take place over the network 150 via an Internet communication protocol. The network 150 may enable the integration of source code data with runtime dependency data within the knowledge graph stored in the graph database 121.

### H.EXAMPLE OPERATION

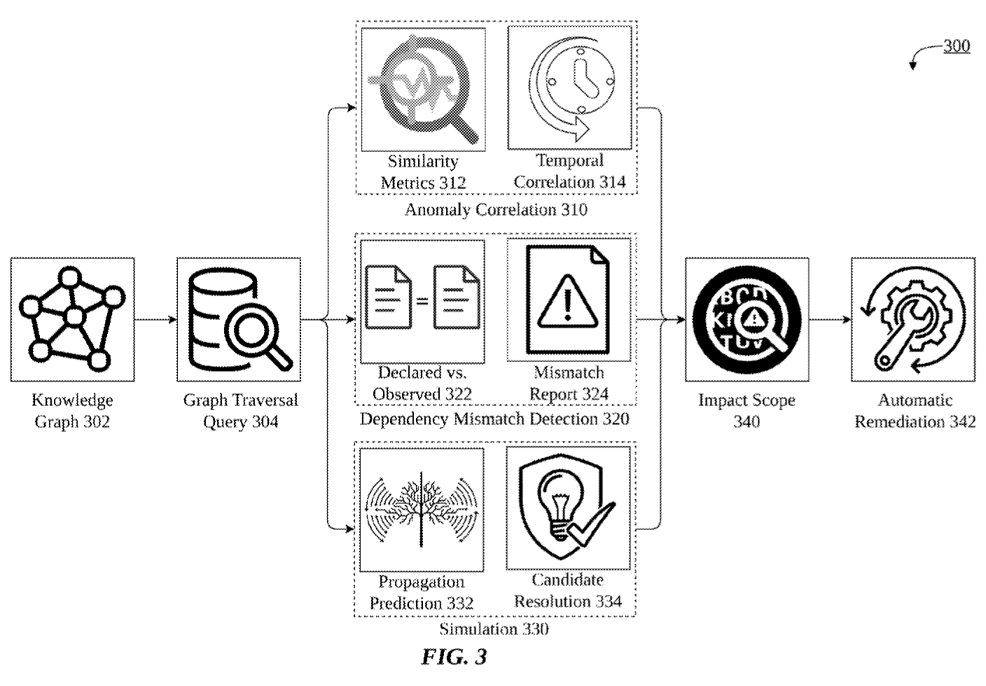

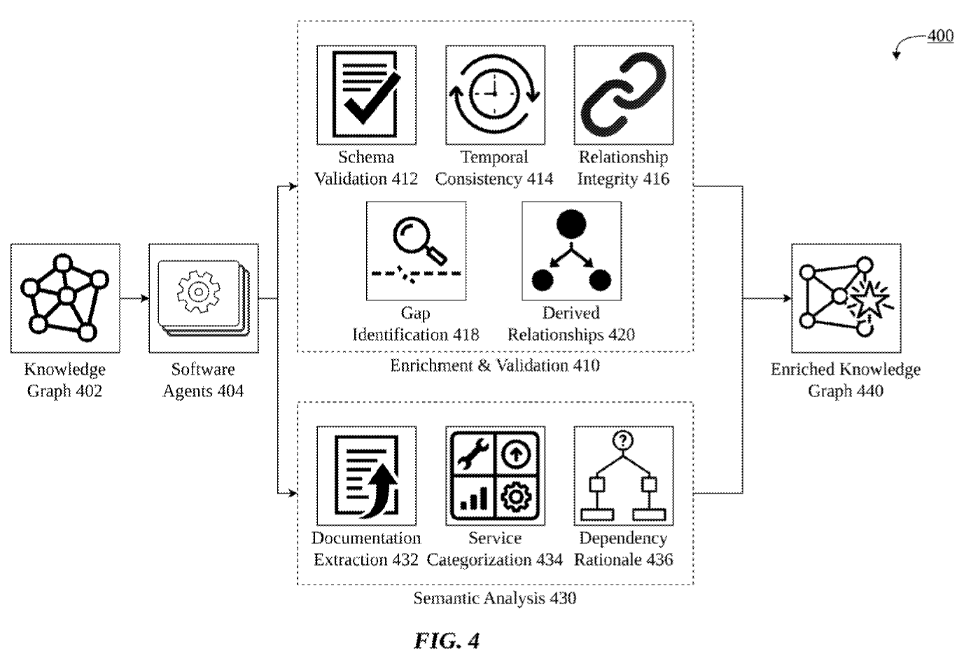

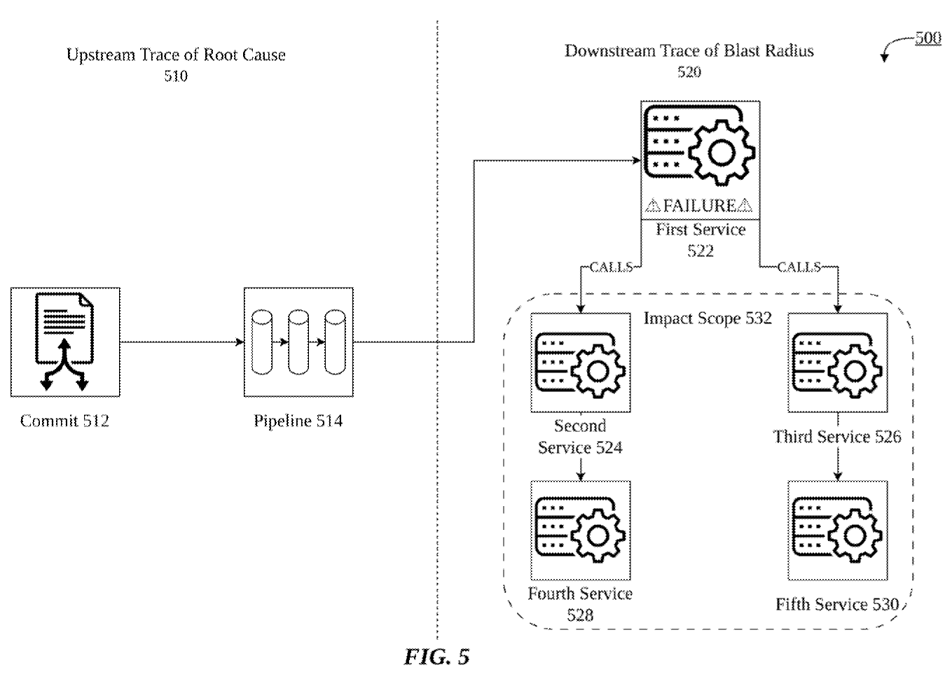

In operation, the source system 140 provides software data to the server 110 via the network 150. The data ingestion module 115 ingests the software data from the source code management module 145 and the runtime monitoring module 146, converts the software data into nodes and edges according to the predefined graph schema, and assembles the nodes and edges into the knowledge graph stored in the graph database 121. The graph analysis module 116 uses software agents to traverse the knowledge graph and discover dependency chains between entities, described in further detail below, with reference to FIG. 3. The agent and language model module 117 performs graph enrichment and validation operations, including semantic analysis using a large language model, described in further detail below, with reference to FIG. 4. When a change or failure event is detected, the graph analysis module 116 determines an impact scope by tracing upstream dependencies (toward root causes) and downstream dependencies (toward affected services) from the originating entity, described in further detail below, with reference to FIG. 5. The simulation module 118 simulates propagation of the change or failure event through the knowledge graph to predict downstream impacts and identify candidate resolutions. Based upon the determined impact scope, the remediation module 119 automatically implements software remediation actions, which may include initiating rollbacks, adjusting resource allocation, modifying traffic routing, scaling computing resources, generating merge request code that addresses detected issues or implements recommended changes, restarting affected services or processes, invalidating or clearing caches, updating configuration settings such as timeout values, connection pool sizes, or retry limits, enabling or disabling feature flags, quarantining or isolating affected components, triggering a new deployment pipeline to deploy a known-good version or hotfix, adjusting rate limits or throttling, and/or generating alerts. The API module 120 provides access to the knowledge graph through an application programming interface that receives queries from users, external systems, and software agents. The client application module 135 on the computing device 130 transmits queries to the server 110 via the network 150, and the visualization module 136 renders visual representations of the knowledge graph including dependency maps, impact visualizations, and entity relationship diagrams on a display of the computing device 130.

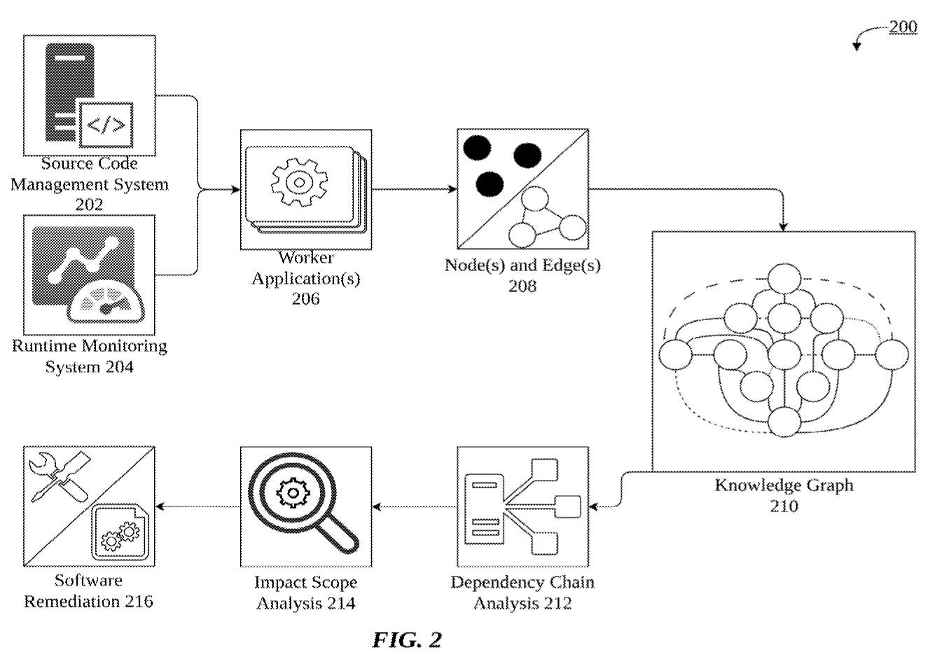

It will be appreciated that although one server 110 is depicted in FIG. 1, multiple servers may be provided for the purpose of distributing processing load, and the server 110 may be disposed in a cloud computing environment or on-premises within an organization’s network infrastructure. This architecture provides technical benefits including unified cross-domain dependency visibility by integrating source code data with runtime dependency data in a single knowledge graph, automated impact scope determination that reduces incident response time from manual correlation efforts to automated bidirectional graph traversal, and automatic remediation that produces concrete changes to the computing environment without involving intervention. The data flow and analysis operations are described in further detail below, with reference to FIGS. 2-6.

### II.EXAMPLE DATA FLOW FOR ANALYZING SOFTWARE DEPENDENCIES

FIG. 2 depicts a system diagram of an example flow 200 for analyzing software application dependencies using a knowledge graph. The flow 200 may be performed by the server 110 as shown in FIG. 1 and its respective components, such as the data ingestion module 115, the graph analysis module 116, the agent and language model module 117, and the remediation module 119. The flow 200 illustrates a data pipeline from source systems through graph construction and analysis to automatic remediation. A source code management system 202 may provide source code data including repositories, commits, and/or deployment pipelines. The source code management system 202 may connect to a source code management platform such as GitLab® to extract information about repositories, branches, commits, merge requests, and/or CI/CD pipelines. A runtime monitoring system 204 (e.g., the runtime monitoring module 146 of the source system 140) may provide runtime dependency data including telemetry, services, and/or performance metrics. The runtime monitoring system 204 may pull runtime data from instrumented resources and derive associations that would not be available from the runtime monitoring platform alone.

A worker application 206, which may operate as part of the data ingestion module 115 of the server 110, may convert incoming software data into graph-compatible structures, producing nodes and edges 208 that conform to a predefined schema. The worker application 206 may connect to source systems via application programming interfaces (APIs) and extract data from the source code management system 202 and/or the runtime monitoring system 204. The worker application 206 may convert source data into nodes and edges 208 following the predefined graph schema and may establish links to create relationships between entities across different domains. The nodes and edges 208 may marry physical deployed entities with logical code representations to provide a more comprehensive view of the system architecture. Physical deployed entities may include runtime services deployed on servers, while logical code representations may include source code, configuration files, and/or deployment pipeline definitions. The knowledge graph may bridge the gap between compiled code that can be traced at runtime through instrumentation and source code that provides logical structure and intent, enabling traceability from runtime behavior back to the original code changes.

The nodes and edges 208 may be used to construct a knowledge graph 210 in a graph database. The knowledge graph 210 may integrate source code data with runtime dependency data. The knowledge graph 210 may store historical analytical data to discover application patterns on resiliency issues over time, enabling pattern recognition across historical incidents. The knowledge graph 210 may serve multiple use cases beyond incident response, including change impact assessment prior to deployment, capacity planning based upon dependency analysis, architectural analysis for modernization initiatives, and compliance auditing through dependency traceability. The knowledge graph 210 may combine runtime dependencies, configuration data, and code to create a representation of the system architecture that enables traceability to impacted applications for root cause analysis and triage.

A dependency chain analysis 212, which may operate as part of the graph analysis module 116 of the server 110, may run queries that traverse the knowledge graph 210 to discover how entities depend on one another. The dependency chain analysis 212 may use software agents to traverse the knowledge graph 210 and determine upstream and downstream dependencies. The dependency chain analysis 212 may navigate a dependency tree upward to determine impact and downward to determine origin.

An impact scope analysis 214, which may operate as part of the graph analysis module 116 of the server 110, may trace upstream and downstream dependencies from an originating entity. The impact scope analysis 214 may enable incident-to-author tracing by following a chain from an incident back through a service, a deployment pipeline, a commit, and an author that introduced the incident. The impact scope analysis 214 may determine a blast radius by finding services multiple hops downstream from an originating entity. The impact scope analysis 214 may provide an internal view of the system architecture that enables visibility both upstream and downstream from a point of failure.

A software remediation 216, which may operate as part of the remediation module 119 of the server 110, may automatically implement remediation actions in response to the determined impact scope. The software remediation 216 may receive the impact scope from the impact scope analysis 214 and may initiate remediation actions to address the change or failure event.

In some implementations, the flow 200 may operate continuously, with the worker application 206 periodically ingesting updated data from the source code management system 202 and the runtime monitoring system 204 to keep the knowledge graph 210 current. In other implementations, the flow 200 may be triggered by specific events such as a new deployment, a detected anomaly, or a manual request from an operations team. The knowledge graph 210 may also integrate data from additional source systems beyond the source code management system 202 and the runtime monitoring system 204, such as incident management and documentation platforms (e.g., ServiceNow® and Confluence®), configuration management databases, or infrastructure-as-code repositories. For example, when a developer commits code to a repository, the worker application 206 may extract the commit metadata, create a Commit node with properties including the author identifier and timestamp, establish a TRIGGERED relationship to any Pipeline nodes initiated by the commit, and link the Commit node to the existing Repository and Branch nodes using the canonical identifiers.

### III.EXAMPLE GRAPH ANALYSIS SUB-FLOW

FIG. 3 depicts a system diagram of an example flow 300 for dependency chain determination, anomaly correlation 310, dependency mismatch detection 320, and simulation 330. The flow 300 illustrates parallel analysis paths that converge to determine an impact scope 340 and trigger an automatic remediation 342. The flow 300 may be performed by the server 110 as shown in FIG. 1 and its respective components.

The flow 300 may begin with a knowledge graph 302. The knowledge graph 302 may include telemetry nodes representing performance metrics associated with service entities. The performance metrics may include latency measurements, error rates, availability metrics, throughput measurements, and/or resource utilization data. The knowledge graph 302, which may operate as part of the graph analysis module 116 of the server 110, may feed into a graph traversal query 304 executed by software agents. The graph traversal query 304 may branch into parallel analysis paths including the anomaly correlation 310, the dependency mismatch detection 320, and the simulation 330.

The anomaly correlation 310 path may include similarity metrics 312 that compare patterns in the performance metrics across multiple service entities to determine services exhibiting correlated degradation. The similarity metrics 312 compare performance patterns (such as latency trends, error rate curves, or throughput fluctuations) across multiple service entities to surface groups of services degrading in tandem, suggesting a shared underlying cause. For example, if a payment service and an authentication service both exhibit latency increases of similar magnitude and timing, the similarity metrics 312 may identify these services as exhibiting correlated degradation, suggesting a shared underlying cause such as a database connection pool exhaustion affecting both services. The anomaly correlation 310 may use golden signal metrics (e.g., latency, traffic, errors, and saturation) fed into anomaly detection models. A large language model may summarize detected changes or failures and provide recommendations for resolution. The anomaly correlation 310 may also include a temporal correlation 314 that correlates detected anomalies with code changes occurring within a predefined time window. The temporal correlation 314 may traverse the knowledge graph 302 to identify commits and deployments temporally associated with the anomalies. The computing environment may continuously monitor errors and error rates as ongoing operational data to detect anomalous conditions including performance issues and unexpected behaviors.

The dependency mismatch detection 320 path may include a declared vs. observed 322 comparison that compares declared dependencies (from source code data) with observed dependencies (from runtime data). A mismatch report 324 flags discrepancies where the source code declarations diverge from what runtime monitoring actually observes during execution.

The simulation 330 path may include a propagation prediction 332 that simulates propagation of a change or failure event through the knowledge graph 302 to predict impacts on downstream entities. The simulation 330 may implement source code in a graph form representing a physical layer of what has been deployed, simulate an error in production, and determine a resolution against the simulation. A candidate resolution 334 may determine a candidate resolution prior to implementing remediation.

The simulation 330 may model failure propagation by traversing the knowledge graph 302 along dependency edges from the originating entity and evaluating the predicted impact at each downstream node. In some implementations, the simulation 330 may use an abstract syntax tree (AST) representation of the system to capture how components interact without having access to the actual source code. The simulation 330 may re-run scenarios with proposed changes applied in graphical form to evaluate whether a candidate resolution addresses the detected issue without introducing new failures.

For example, the simulation 330 may model the effect of rolling back a specific deployment by removing the corresponding edges and nodes from the simulated graph and evaluating whether downstream services recover. In another example, the simulation 330 may model the effect of scaling a particular service by adjusting performance metric values associated with that service node and evaluating whether correlated degradation in downstream services is resolved. The simulation 330 may leverage the breadth of content in the knowledge graph 302, including data quality expectations, historical incident patterns, and dependency chains of arbitrary depth, to produce more accurate predictions. In some implementations, a large language model may assist the simulation 330 by analyzing the root cause and predicting the outcome of proposed changes based upon patterns observed in the knowledge graph 302.

The parallel paths may converge into the impact scope 340. The impact scope 340 may aggregate results from the anomaly correlation 310, the dependency mismatch detection 320, and the simulation 330. Determining the impact scope 340 may involve comparing performance patterns across service entities to find services degrading in tandem, and correlating detected anomalies with recent code changes by traversing the knowledge graph 302 to find commits and deployments that occurred within a relevant time window.

The impact scope 340, which may operate as part of the graph analysis module 116 of the server 110, may feed into the automatic remediation 342. The automatic remediation 342 may roll back a recent deployment, adjust resource quotas for affected services, reroute traffic around failing components, scale up computing resources for services within the impact scope 340, generate merge request code that addresses detected issues or implements recommended changes, restart affected services or processes, invalidate or clear caches, update configuration settings such as timeout values, connection pool sizes, or retry limits, enable or disable feature flags, quarantine or isolate affected components, trigger a new deployment pipeline to deploy a known-good version or hotfix, adjust rate limits or throttling, and/or send alerts to operations teams identifying the affected area and impacted entities.

In some implementations, the parallel analysis paths (anomaly correlation 310, dependency mismatch detection 320, and simulation 330) may operate independently and asynchronously, with each path contributing results to the impact scope 340 as they become available. In other implementations, the paths may execute sequentially, with the output of one path informing the analysis of subsequent paths. For example, the anomaly correlation 310 may first identify a set of correlated services, and the simulation 330 may then simulate failure propagation specifically within that correlated set to refine the impact scope 340. The automatic remediation 342 may select different remediation strategies based upon the severity and type of the detected issue. For example, a minor performance degradation may trigger resource scaling, while a complete service failure may trigger a deployment rollback combined with traffic rerouting.

### IV.EXAMPLE AGENT OPERATIONS SUB-FLOW

FIG. 4 depicts a system diagram of an agent operations sub-flow 400 for enriching and validating a knowledge graph using software agents. The agent operations sub-flow 400 illustrates how software agents process a knowledge graph 402 through enrichment, validation, and semantic analysis paths to produce an enriched knowledge graph 440. The process 400 may be performed by the server 110 as shown in FIG. 1 and its respective components.

The agent operations sub-flow 400 may begin with the knowledge graph 402, which may feed into software agents 404, which may operate as part of the agent and language model module 117 of the server 110. The software agents 404 may include executable software configured to (i) access the knowledge graph 402, (ii) process query results, and/or (iii) initiate operations based upon predefined conditions or learned patterns. The software agents 404 may run graph traversal queries (e.g., Cypher queries) to find patterns or anomalies within the knowledge graph 402. The software agents 404 may analyze results by applying rules, heuristics, and/or machine learning models to determine insights. The software agents 404 may take action by creating new relationships, flagging issues, and/or generating reports. The software agents 404 may branch into parallel paths including an enrichment and validation 410 path and a semantic analysis 430 path.

The enrichment and validation 410 path may perform graph enrichment and validation operations including: a schema validation 412 operation that verifies one or more nodes have properties according to the predefined graph schema; a temporal consistency 414 operation that flags nodes not updated within a predefined time period; a relationship integrity 416 operation that traverses edges to verify relationship endpoints exist and that circular dependency patterns do not create infinite loops; a gap identification 418 operation that locates entities without ownership assignments, repositories lacking documentation, and resources that exist in isolation without service connections; and a derived relationships 420 operation that infers new relationships from patterns observed across existing nodes and edges in the knowledge graph 402.

The enrichment and validation 410 path may build behavioral profiles by team. The behavioral profiles may include change frequency (e.g., how often a team commits changes), change size (e.g., the magnitude of changes in terms of lines of code or files modified), and/or patterns of changes on changes such as reversions or quick fixes. The behavioral profiles may enable the software agents 404 to detect anomalous team behaviors that correlate with resiliency issues.

The enrichment and validation 410 path may perform data payload analysis to track how data morphs as data migrates downstream through an application. The data payload analysis may detect when data changes outside normal boundaries even when no error is thrown. The data payload analysis may compare data values at different points in a processing pipeline represented in the knowledge graph 402 and may flag deviations that exceed predefined thresholds.

The software agents may handle incomplete or conflicting data within the knowledge graph. For example, a deployed service with no matching source code repository may be flagged by the gap identification operations as an orphaned resource warranting investigation. Source code that has not been deployed may be identified through the absence of a DEPLOYED_AS relationship connecting a repository node to a service node. Conflicting data, such as a runtime dependency observed between two services that is not declared in the source code, may be identified by the dependency mismatch detection operations described with reference to FIG. 3. The software agents may flag these discrepancies for review, assign lower confidence scores to uncertain relationships, and/or generate reports identifying areas of the knowledge graph that warrant verification.

The semantic analysis 430 path may use a large language model (LLM) to semantically analyze the knowledge graph 402, including: a documentation extraction 432 operation that processes README files, code comments, and other documentation to extract purpose and capability descriptions for services; a service categorization 434 operation that classifies services into functional categories based upon analysis of service nodes and associated documentation; and a dependency rationale 436 operation that determines why services are connected by examining code references, configuration files that specify service endpoints, and communication patterns observed in runtime telemetry. For example, the dependency rationale 436 operation may determine that a first service connects to a second service because the first service's configuration file specifies the second service's endpoint URL, and runtime telemetry confirms HTTP requests flowing between the services.

The semantic analysis 430 path may produce merge request code as output from a change analysis process. The merge request code may enable automated code change recommendations. The software agents 404 may generate merge request code that addresses detected issues or implements recommended changes based upon the semantic analysis.

The parallel paths may converge into the enriched knowledge graph 440. The enriched knowledge graph 440 may include updated nodes, edges, and provenance metadata. The provenance metadata may include source system identifiers, last updated timestamps, agent source identifiers, confidence scores, and/or creation timestamps.

In some implementations, the enrichment and validation 410 path and the semantic analysis 430 path may operate iteratively, with each iteration improving the quality and completeness of the knowledge graph 402. For example, a first iteration may identify orphaned resources and missing ownership, a second iteration may infer connections between the orphaned resources and existing services based upon naming conventions, and a third iteration may use the large language model to validate the inferred connections by analyzing documentation and code references. The enriched knowledge graph 440 may serve as the input for subsequent analysis operations, including the dependency chain analysis, anomaly correlation, simulation, and dependency mismatch detection described with reference to FIGS. 2 and 3.

The computing environment may associate nodes with source provenance metadata including a source system identifier and a last updated timestamp. The source system identifier may indicate the origin of the node data (e.g., a source code management system or a runtime monitoring system). The last updated timestamp may indicate when the node was last refreshed from the source system.

The computing environment may tag agent-generated data with an agent source identifier, a confidence score, and a creation timestamp. The agent source identifier may indicate which software agent created or modified the data. The confidence score may indicate a level of certainty associated with agent-generated relationships or classifications. The creation timestamp may indicate when the agent created the data. The provenance metadata may enable users and systems to distinguish between data ingested from source systems and data derived by software agents.

### V.EXAMPLE IMPACT SCOPE

FIG. 5 depicts a system diagram of an impact scope visualization 500 showing upstream root cause tracing and downstream blast radius determination. The visualization 500 may be generated by the server 110, as shown in FIG. 1 and its respective components, such as the graph analysis module 116 and the visualization module 136 of the computing device 130. The visualization 500 illustrates how a failure event propagates through a knowledge graph by tracing both upstream root causes and downstream affected services. An upstream trace of root cause 510 depicts the origin of a failure event. The upstream trace of root cause 510 enables the computing environment to trace from an incident back through deployment infrastructure to determine the root cause chain. For example, when a payment service experiences elevated error rates, the upstream trace of root cause 510 may traverse from the payment service node through a “DEPLOYED_AS” relationship to a pipeline node, through a “TRIGGERED” relationship to a commit node, identifying that a particular commit introduced a database query change that caused the elevated error rates.

A commit 512 represents a code change that introduced the failure event. The commit 512 corresponds to a node in the knowledge graph representing a specific code modification within a source code management system. The commit 512 includes metadata such as an author identifier, a commit message, and a timestamp indicating when the code change was made. The commit 512 feeds into a pipeline 514 consisting of one or more deployment stages. The pipeline 514 represents a continuous integration and continuous deployment (CI/CD) pipeline that builds, tests, and/or deploys the code change represented by the commit 512. The pipeline 514 connects to the downstream section, indicating that the deployment introduced the change or failure into the runtime environment.

A downstream trace of blast radius 520 may depict the propagation of the failure through downstream dependencies. The downstream trace of blast radius 520 may enable the computing environment to determine the scope of services affected by the failure event by traversing dependency relationships in the knowledge graph. A first service 522 receives the deployment from the pipeline 514 and serves as the originating entity for the change or failure event. The first service 522 corresponds to a service node in the knowledge graph that represents a deployed runtime service within the software architecture.

Within the impact scope 532, the first service 522 may call a second service 524 and/or a third service 526. The second service 524 and the third service 526 represent downstream services that depend on the first service 522 and are affected by the failure event. The “CALLS” relationship type in the knowledge graph represents these service-to-service dependencies.

The second service 524 may connect downstream to a fourth service 528. The third service 526 may connect downstream to a fifth service 530. The fourth service 528 and the fifth service 530 may represent additional downstream services that are transitively affected by the failure event through the dependency chain.

The downstream services within the impact scope 532 represent the blast radius determined by tracing downstream dependencies from the originating entity. The impact scope 532 encompasses services that are one or more hops downstream from the first service 522. The computing environment traverses the knowledge graph following “CALLS” edges to determine services within the impact scope 532.

The visualization 500 illustrates bidirectional analysis of failure events. The upstream trace of root cause 510 enables the computing environment to follow a chain from an incident back to a commit and author that introduced the incident. The downstream trace of blast radius 520 enables the computing environment to find services multiple hops downstream to understand the blast radius. The bidirectional traversal provides visibility both upstream and downstream from a point of failure within the software architecture.

The impact scope 532 may inform software remediation actions. The computing environment may use the determined impact scope 532 to initiate rollback of a deployment associated with the commit 512, adjust resource allocation for affected services within the impact scope 532, modify traffic routing to bypass the first service 522, scale computing resources allocated to services within the impact scope 532, and/or generate and transmit an alert identifying the impact scope 532 and affected entities.

In some implementations, the impact scope 532 may be dynamically updated as new information becomes available. For example, if the remediation module initiates a rollback of the deployment associated with the commit 512, the computing environment may re-evaluate the impact scope 532 to determine whether the downstream services have recovered. The visualization 500 may also support proactive use cases beyond incident response. In a change impact assessment use case, the computing environment may simulate the effect of a proposed code change by tracing the dependency chains from the affected repository through the deployment pipeline to downstream services, enabling operations teams to evaluate the potential blast radius before the change is deployed to production. In another use case, the visualization 500 and subsequent analysis thereof may support continuous monitoring by periodically re-evaluating the impact scope for known issues and alerting operations teams when the blast radius expands due to new dependencies or configuration changes. The computing environment may also implement graduated remediation, starting with less disruptive actions (e.g., scaling resources) before escalating to more disruptive actions (e.g., rollback) if the initial actions do not resolve the failure.

### VI.EXEMPLARY METHOD FOR ANALYZING SOFTWARE DEPENDENCIES

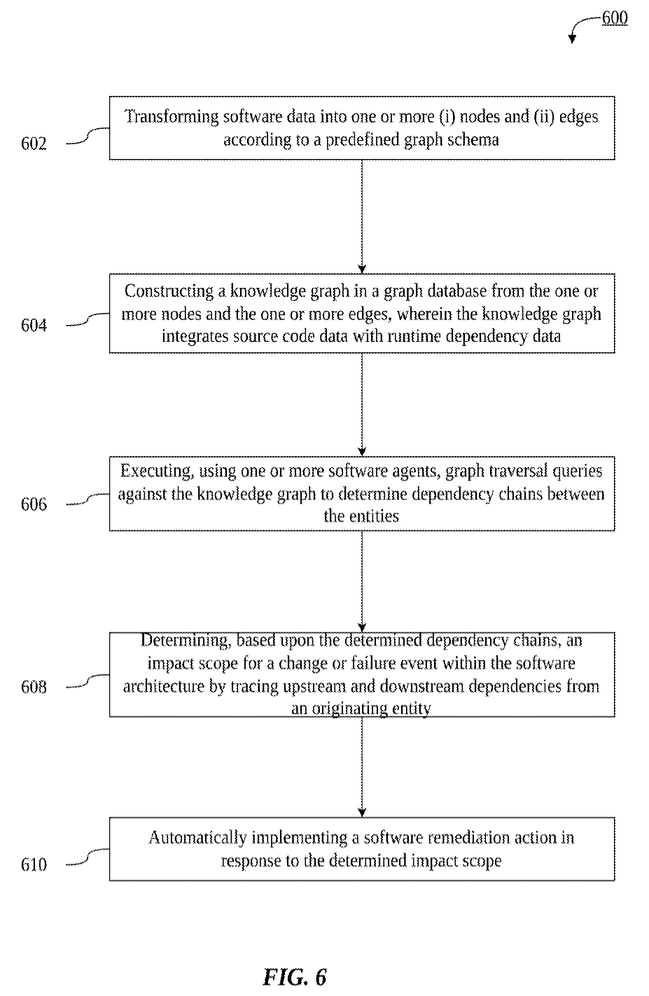

FIG. 6 depicts a flowchart of an exemplary computer-implemented or computer-based method 600 for analyzing software application dependencies in an enterprise software system using a knowledge graph. The method 600 may be executed on a server. In some embodiments, the method 600 may be implemented in a set of instructions stored on a non-transitory computer-readable storage medium and executable on one or more processors of the server. The non-transitory computer-readable storage medium may store executable instructions for analyzing software application dependencies in an enterprise software system using a knowledge graph, wherein the instructions, when executed by one or more processors, cause the one or more processors to perform the operations described below. For example, the method 600 may be performed by the data ingestion module 115, the graph analysis module 116, the agent and language model module 117, the simulation module 118, and/or the remediation module 119 of FIG. 1.

The method 600 includes transforming software data into one or more (i) nodes and (ii) edges according to a predefined graph schema, where each node of the one or more nodes represents an entity within a software architecture, each edge of the one or more edges represents a relationship between entities, and entities include software components and infrastructure resources within the software architecture (block 602), which may be performed by the data ingestion module 115. Software components may include source code repositories, deployment pipelines, and/or runtime services. Infrastructure resources may include servers, containers, databases, and/or network components. The predefined graph schema may define node types, edge types, and/or properties associated with nodes and edges.

The software data may be received from source systems including a source code management system (e.g., the source code management module 145) and a runtime monitoring system (e.g., the runtime monitoring module 146). The source code management system may provide source code data including repository information, branch data, commit histories, merge requests, and continuous integration and continuous deployment (CI/CD) pipeline data. The runtime monitoring system may provide runtime dependency data including runtime telemetry data for instrumented resources including services, hosts, process groups, and custom devices. In some implementations, the software data may further include configuration data such as deployment manifests, infrastructure-as-code definitions, and service configuration files.

The transforming may be performed by one or more worker applications operating as part of a data ingestion module. Each worker application may focus on a specific source system and may connect to the source system via an API to extract relevant data. For example, a source code worker may connect to a source code management platform (e.g., GitLab®) to extract information about repositories, branches, commits, merge requests, and CI/CD pipelines. A runtime monitoring worker may pull runtime data from a runtime monitoring platform (e.g., Dynatrace®) and derive associations that would not be available from the runtime monitoring platform alone. Each worker application may convert source data into nodes and edges following the predefined graph schema and may establish links to create relationships between entities across different domains.

The method 600 further includes constructing a knowledge graph in a graph database from the one or more nodes and the one or more edges, wherein the knowledge graph integrates source code data with runtime dependency data (block 604), which may be performed by the data ingestion module 115. Source code data may include version control information, commit histories, branch structures, merge requests, and/or continuous integration and continuous deployment (CI/CD) pipeline definitions. Runtime dependency data may include telemetry data, service-to-service communication patterns, and/or performance metrics collected from deployed services. The knowledge graph may combine runtime dependencies, configuration data, and code to create a representation of the system architecture that enables traceability to impacted applications for root cause analysis and triage.

The knowledge graph may store historical analytical data to discover application patterns on resiliency issues over time, enabling pattern recognition across historical incidents. The knowledge graph may marry physical deployed entities (runtime services deployed on servers) with logical code representations (source code, configuration files, and deployment pipeline definitions) to provide a more comprehensive view of the system architecture.

In some implementations, the method 600 may associate each node with source provenance metadata including a source system identifier and a last updated timestamp. The source system identifier may indicate the origin of the node data (e.g., a source code management system or a runtime monitoring system). The last updated timestamp may indicate when the node was last refreshed from the source system. The method 600 may also tag agent-generated data with an agent source identifier, a confidence score, and a creation timestamp, enabling users and systems to distinguish between data ingested from source systems and data derived by software agents.

The method 600 further includes executing, using one or more software agents, graph traversal queries against the knowledge graph to determine dependency chains between the entities (block 606), which may be performed by the graph analysis module 116. The one or more software agents may include executable software configured to access the knowledge graph, process query results, and/or initiate operations based upon predefined conditions or learned patterns. The graph traversal queries may traverse edges in the knowledge graph to discover paths between nodes representing different entities. The knowledge graph may support a GraphQL® application programming interface (API) for consumption, enabling users, external systems, and AI agents (e.g., software agents that use artificial intelligence techniques such as machine learning models or large language models) to query the graph through a common interface. The interface may abstract the complexity of direct graph query languages while preserving the power of graph traversal.

The one or more software agents may include executable software configured to access the knowledge graph, process query results, and initiate operations based upon predefined conditions or learned patterns. The software agents may query the knowledge graph, analyze results, and take action based upon the analysis. Agent-created data may be tagged with provenance information including a source identifier, a confidence score, and a timestamp.

The software agents may perform graph enrichment and validation operations including schema compliance validation to ensure nodes have specified (e.g., expected) properties, temporal consistency analysis to flag data not updated within a predefined time period, relationship integrity checking to identify broken links or circular dependencies, identifying missing ownership for entities, identifying documentation gaps for repositories, identifying orphaned resources not linked to any service, and creating derived relationships by analyzing patterns across existing nodes and edges. In some implementations, at least one software agent may use a large language model (LLM) to semantically analyze the knowledge graph, including extracting purpose and capabilities from documentation, categorizing services by function, and determining dependency rationale for connections between services based upon code references, configuration settings, or communication patterns.

The graph traversal queries may include finding all services affected by a repository change by traversing from a repository node through deployment relationships (e.g., DEPLOYED_AS) and service dependency relationships (e.g., CALLS), tracing a failure back to its source by following a chain from an incident node through causal relationships (e.g., CAUSED), deployment relationships (e.g., DEPLOYED_AS), trigger relationships (e.g., TRIGGERED), and authorship relationships (e.g., AUTHORED) to identify the User who authored the commit that introduced the failure, and discovering service dependencies up to a configurable number of hops downstream to understand a blast radius. The knowledge graph may support a GraphQL® application programming interface (API) for consumption, enabling users, external systems, and AI agents to query the graph through a common (e.g., unified) interface.

The method 600 further includes determining, based upon the determined dependency chains, an impact scope for a change or failure event within the software architecture by tracing upstream and downstream dependencies from an originating entity (block 608), which may be performed by the graph analysis module 116. Tracing upstream dependencies may enable the method 600 to follow a chain from an incident back through a service, a deployment pipeline, a commit, and an author that introduced the incident. Tracing downstream dependencies may enable the method 600 to determine (e.g., understand) a blast radius by finding services multiple hops downstream from the originating entity. The impact scope may encompass services that are one or more hops upstream and/or downstream from the originating entity.

In some implementations, the knowledge graph may include telemetry nodes representing performance metrics associated with service entities, wherein the performance metrics include at least one of latency measurements, error rates, availability metrics, throughput measurements, or resource utilization data. Determining the impact scope may include correlating detected anomalies with contributing factors by calculating similarity metrics (e.g., cosine similarity) by comparing patterns in the performance metrics across multiple service entities to identify services exhibiting correlated degradation. Determining the impact scope may also include correlating detected anomalies with code changes occurring within a predefined time window by traversing the knowledge graph to identify commits and deployments temporally associated with the anomalies.

In some implementations, the method 600 may include simulating propagation of the change or failure event through the knowledge graph to predict one or more impacts on downstream entities. The simulation may use a code representation format, such as an abstract syntax tree (AST) format, to capture the syntax and behavior of the system without requiring the actual source code. Other code representation formats may include control flow graphs, data flow graphs, or intermediate representations that model system behavior. The method 600 may further include identifying, based upon the simulation, a candidate resolution prior to implementing the software remediation action. The simulation may enable self-healing opportunities where the system detects a root cause, identifies the outcome of proposed changes, and simulates those changes to evaluate whether the proposed changes resolve the detected issue without introducing new failures.

In some implementations, the method 600 may include comparing declared dependencies derived from the source code data with observed dependencies derived from the runtime dependency data. The method 600 may further include identifying a dependency mismatch where a declared dependency differs from an observed dependency. The dependency mismatch detection may identify configuration drift where the actual runtime behavior of the system diverges from what the source code declares.

The method 600 further includes automatically implementing a software remediation action in response to the determined impact scope (block 610), which may be performed by the remediation module 119. The software remediation action may include initiating a rollback of a deployment associated with the change or failure event, adjusting resource allocation for an affected service identified (e.g., determined) within the dependency chains, modifying traffic routing to bypass a component determined as failing within the impact scope, scaling computing resources allocated to one or more services within the impact scope, and/or generating and transmitting an alert to a designated operations channel identifying the impact scope and affected entities.

In some implementations, the output of the software remediation action may include merge request code as automated code change recommendations. The method 600 may generate merge request code that addresses detected issues or implements recommended changes based upon the analysis performed in blocks 606 and 608.

The method 600 may also cause a visual representation of at least a portion of the knowledge graph to be displayed by a user interface. The visual representation may include at least one of a dependency map depicting the dependency chains, an impact visualization depicting the determined impact scope, or an entity relationship diagram depicting connections between entities. A user may interact with the visual representation to select a particular node, causing the user interface to highlight the edges and connected nodes associated with the selected node.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘_______’ is hereby defined to mean…” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for analyzing software application dependences, through the principles disclosed herein. Therefore, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

What is claimed is:

1. A computer-implemented method for analyzing software application dependencies in an enterprise software system using a knowledge graph, comprising:
transforming, by one or more processors, software data into one or more (i) nodes and (ii) edges according to a predefined graph schema, wherein:
each node of the one or more nodes represents an entity within a software architecture,
each edge of the one or more edges represents a relationship between entities, and
entities include software components and infrastructure resources within the software architecture;
constructing, by the one or more processors, a knowledge graph in a graph database from the one or more nodes and the one or more edges,
wherein the knowledge graph integrates source code data with runtime dependency data;
analyzing, by the one or more processors, the software architecture by:
executing, by the one or more processors using one or more software agents, graph traversal queries against the knowledge graph to determine dependency chains between the entities; and
determining, based upon the determined dependency chains, an impact scope for a change or failure event within the software architecture by tracing upstream and downstream dependencies from an originating entity; and
automatically implementing, by the one or more processors, a software remediation action in response to the determined impact scope.

2. The computer-implemented method of claim 1, wherein at least one software agent of the one or more software agents includes executable software configured to (i) access the knowledge graph, (ii) process query results, or (iii) initiate operations based upon one or more predefined conditions or learned patterns, and wherein the at least one software agent performs graph enrichment and validation operations including at least one of:
schema compliance validation on one or more nodes for properties;
temporal consistency analysis to flag data not updated within a predefined time period;
relationship integrity checking to identify broken links or circular dependencies;
identifying missing ownership for entities;
identifying documentation gaps for repositories;
identifying orphaned resources not linked to any service; or
creating derived relationships by analyzing patterns across existing nodes and edges in the knowledge graph.

3. The computer-implemented method of claim 1, wherein at least one software agent of the one or more software agents uses a large language model (LLM) to semantically analyze the knowledge graph, including at least one of:
extracting purpose and capabilities from documentation,
categorizing services by function, or
determining dependency rationale for connections between services based upon code references, configuration settings, or communication patterns.

4. The computer-implemented method of claim 1, wherein the knowledge graph includes telemetry nodes representing performance metrics associated with service entities, wherein the performance metrics include at least one of latency measurements, error rates, availability metrics, throughput measurements, or resource utilization data, and
wherein determining the impact scope includes correlating one or more detected anomalies with contributing factors by at least one of:
calculating similarity metrics by comparing patterns in the performance metrics across multiple service entities to identify services exhibiting correlated degradation; or
correlating the one or more detected anomalies with code changes occurring within a predefined time window by traversing the knowledge graph to identify commits and deployments temporally associated with the anomalies.

5. The computer-implemented method of claim 1, further comprising:
associating, by the one or more processors, each node with source provenance metadata including a source system identifier and a last updated timestamp; and
tagging, by the one or more processors, agent-generated data with an agent source identifier, a confidence score, and a creation timestamp.

6. The computer-implemented method of claim 1, further comprising:
providing, by the one or more processors, access to the knowledge graph through an application programming interface configured to receive queries from users, external systems, and the one or more software agents and to return query results while preserving graph traversal capabilities; and
causing, by the one or more processors, a visual representation of at least a portion of the knowledge graph to be displayed by a user interface,
wherein the visual representation includes at least one of a dependency map, an impact visualization, or an entity relationship diagram.

7. The computer-implemented method of claim 1, further comprising:
simulating, by the one or more processors, propagation of the change or failure event through the knowledge graph to predict one or more impacts on downstream entities; and
identifying, by the one or more processors based upon the simulating, a candidate resolution prior to implementing the software remediation action.

8. The computer-implemented method of claim 1, further comprising:
comparing, by the one or more processors, declared dependencies derived from the source code data with observed dependencies derived from the runtime dependency data; and
identifying a dependency mismatch where a declared dependency differs from an observed dependency.

9. The computer-implemented method of claim 1, wherein the software remediation action includes at least one of:
initiating a rollback of a deployment associated with the change or failure event,
adjusting resource allocation for an affected service identified within the dependency chains,
modifying traffic routing to bypass a component identified as failing within the impact scope,
scaling computing resources allocated to one or more services within the impact scope, or
generating and transmitting an alert to a designated operations channel identifying the impact scope and affected entities.

10. A computer system for analyzing software application dependencies in an enterprise software system using a knowledge graph, the computer system comprising:
one or more processors; and
a memory storing executable instructions thereon that, when executed by the one or more processors, cause the one or more processors to:
transform software data into one or more (i) nodes and (ii) edges according to a predefined graph schema, wherein each node of the one or more nodes represents an entity within a software architecture, each edge of the one or more edges represents a relationship between entities, and entities include software components and infrastructure resources within the software architecture,
construct a knowledge graph in a graph database from the one or more nodes and the one or more edges, wherein the knowledge graph integrates source code data with runtime dependency data,
execute, using one or more software agents, graph traversal queries against the knowledge graph to determine dependency chains between the entities,
determine, based upon the determined dependency chains, an impact scope for a change or failure event within the software architecture by tracing upstream and downstream dependencies from an originating entity, and
automatically implement a software remediation action in response to the determined impact scope.

11. The computer system of claim 10, wherein at least one software agent of the one or more software agents includes executable software configured to (i) access the knowledge graph, (ii) process query results, or (iii) initiate operations based upon one or more predefined conditions or learned patterns, and wherein the at least one software agent performs graph enrichment and validation operations including at least one of:
schema compliance validation on one or more nodes for properties,
temporal consistency analysis to flag data not updated within a predefined time period,
relationship integrity checking to identify broken links or circular dependencies,
identifying missing ownership for entities,
identifying documentation gaps for repositories,
identifying orphaned resources not linked to any service, or
creating derived relationships by analyzing patterns across existing nodes and edges in the knowledge graph.

12. The computer system of claim 10, wherein at least one software agent of the one or more software agents uses a large language model (LLM) to semantically analyze the knowledge graph, including at least one of:
extracting purpose and capabilities from documentation,
categorizing services by function, or
determining dependency rationale for connections between services based upon code references, configuration settings, or communication patterns.

13. The computer system of claim 10, wherein the knowledge graph includes telemetry nodes representing performance metrics associated with service entities, wherein the performance metrics include at least one of latency measurements, error rates, availability metrics, throughput measurements, or resource utilization data, and
wherein determining the impact scope includes correlating one or more detected anomalies with contributing factors by at least one of:
calculating similarity metrics by comparing patterns in the performance metrics across multiple service entities to identify services exhibiting correlated degradation, or
correlating the one or more detected anomalies with code changes occurring within a predefined time window by traversing the knowledge graph to identify commits and deployments temporally associated with the anomalies.

14. The computer system of claim 10, wherein the instructions, when executed by the one or more processors, further cause the one or more processors to:
associate each node with source provenance metadata including a source system identifier and a last updated timestamp, and
tag agent-generated data with an agent source identifier, a confidence score, and a creation timestamp.

15. The computer system of claim 10, wherein the instructions, when executed by the one or more processors, further cause the one or more processors to:
provide access to the knowledge graph through an application programming interface configured to receive queries from users, external systems, and the one or more software agents and to return query results while preserving graph traversal capabilities, and
cause a visual representation of at least a portion of the knowledge graph to be displayed by a user interface, wherein the visual representation includes at least one of a dependency map, an impact visualization, or an entity relationship diagram.

16. The computer system of claim 10, wherein the instructions, when executed by the one or more processors, further cause the one or more processors to:
simulate propagation of the change or failure event through the knowledge graph to predict one or more impacts on downstream entities, and
identify, based upon the simulating, a candidate resolution prior to implementing the software remediation action.

17. The computer system of claim 10, wherein the instructions, when executed by the one or more processors, further cause the one or more processors to:
compare declared dependencies derived from the source code data with observed dependencies derived from the runtime dependency data, and
identify a dependency mismatch where a declared dependency differs from an observed dependency.

18. The computer system of claim 10, wherein the software remediation action includes at least one of:
initiating a rollback of a deployment associated with the change or failure event,
adjusting resource allocation for an affected service identified within the dependency chains,
modifying traffic routing to bypass a component identified as failing within the impact scope,
scaling computing resources allocated to one or more services within the impact scope, or
generating and transmitting an alert to a designated operations channel identifying the impact scope and affected entities.

19. A non-transitory computer-readable storage medium storing executable instructions for analyzing software application dependencies in an enterprise software system using a knowledge graph, wherein the instructions, when executed by one or more processors, cause the one or more processors to:
transform software data into one or more (i) nodes and (ii) edges according to a predefined graph schema, wherein each node of the one or more nodes represents an entity within a software architecture, each edge of the one or more edges represents a relationship between entities, and entities include software components and infrastructure resources within the software architecture,
construct a knowledge graph in a graph database from the one or more nodes and the one or more edges, wherein the knowledge graph integrates source code data with runtime dependency data,
execute, using one or more software agents, graph traversal queries against the knowledge graph to determine dependency chains between the entities,
determine, based upon the determined dependency chains, an impact scope for a change or failure event within the software architecture by tracing upstream and downstream dependencies from an originating entity, and
automatically implement a software remediation action in response to the determined impact scope.

20. The non-transitory computer-readable storage medium of claim 19, wherein at least one software agent of the one or more software agents includes executable software configured to (i) access the knowledge graph, (ii) process query results, or (iii) initiate operations based upon one or more predefined conditions or learned patterns, and wherein the at least one software agent performs graph enrichment and validation operations including at least one of:
schema compliance validation on one or more nodes for properties,
temporal consistency analysis to flag data not updated within a predefined time period,
relationship integrity checking to identify broken links or circular dependencies,
identifying missing ownership for entities,
identifying documentation gaps for repositories,
identifying orphaned resources not linked to any service, or
creating derived relationships by analyzing patterns across existing nodes and edges in the knowledge graph.
